(19) United States
(12) Patent Application Publication
(10) Pub. No.: US 2009/0030592 A1
(43) Pub. Date: Jan. 29, 2009

(54) Catalyst Deterioration Detecting Apparatus of Vehicle Internal Combustion Engine

(75) Inventor: Noritake Mitsutani, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/887,444

(22) PCT Filed: Mar. 15, 2007
(86) PCT No.: PCT/JP2007/055934

§ 371 Date: Sep. 28, 2007

(30) Foreign Application Priority Data
Mar. 15, 2006 (JP) 2006-070863

(51) Int. Cl. F02D 41/04; G01M 15/10

(52) U.S. Cl. 701/109; 73/114.75; 73/114.73

(57) ABSTRACT

A determining section integrates amount of oxygen that is stored in or released from a exhaust gas purifying catalyst from when a signal from an oxygen sensor is changed until when the signal is changed subsequently, thereby calculating an oxygen storage capacity. The determining section uses the calculated oxygen storage capacity to determine a deterioration state of the exhaust gas purifying catalyst. A limiting section sets, as an allowable change amount, a change amount of the air-fuel ratio that corresponds to an allowable maximum fluctuation amount of a torque of a output shaft of the engine. The limiting section limits a change of the target air-fuel ratio such that a change amount of the target air-fuel ratio due to a change of the signal does not exceed the allowable change amount. Therefore, a deterioration of a drivability while ensuring opportunities of detecting a deterioration of an exhaust gas purifying catalyst is suppressed.

### TECHNICAL FIELD

The present invention relates to a catalyst deterioration detecting apparatus of a vehicle internal combustion engine which detects a deteriorated state of an exhaust gas purifying catalyst arranged in an exhaust passage of the vehicle internal combustion engine.

### BACKGROUND ART

In an internal combustion engine mounted in a vehicle, a purification of exhaust gas components is generally executed by an exhaust gas purifying catalyst arranged in an exhaust passage. The exhaust gas purifying catalyst has an oxygen storage capacity OSC, and can store oxygen in a range of the oxygen storage capacity OSC. In the case that an unburned components such as hydro carbon (HC), carbon monoxide (CO) or the like is contained in the exhaust gas, the exhaust gas purifying catalyst oxidizes the unburned component by releasing the stored oxygen. Further, in the case that oxygen, nitrogen oxide (NOx) or the like is much contained in the exhaust gas, the exhaust gas purifying catalyst stores surplus oxygen.

The purification of the exhaust gas component by the exhaust gas purifying catalyst mentioned above is efficiently executed in the case that an air-fuel ratio of an air-fuel mixture burned in the internal combustion engine is within a predetermined range. Accordingly, a sensor outputting a signal corresponding to a concentration of the oxygen in the exhaust gas is provided in an upstream side of the exhaust gas purifying catalyst, the air-fuel ratio of the air-fuel mixture is detected on the basis of the output signal, and an air-fuel ratio control correcting so as to increase and decrease a fuel injection amount is executed in such a manner that the detected air-fuel ratio agrees with a target air-fuel ratio.

Further, in order to detect a purified state of the exhaust gas components caused by the exhaust gas purifying catalyst, there has been known a structure in which a sensor outputting a signal corresponding to a concentration of oxygen in the exhaust gas is also provided in a downstream side of the exhaust gas purifying catalyst, and an air-fuel ratio control correcting so as to increase and decrease the fuel injection amount is executed on the basis of the output signal.

In the exhaust gas purifying catalyst mentioned above, in accordance with a progress of the deterioration, the oxygen storage capacity OSC is reduced and the exhaust gas purifying performance is lowered. In order to achieve a good exhaust gas purifying performance of the exhaust gas purifying catalyst, it is important to have a proper oxygen storage capacity OSC. Accordingly, it is desirable to detect the oxygen storage capacity OSC so as to detect a deterioration state of the exhaust gas purifying catalyst.

Accordingly, there has been proposed a technique which calculates the oxygen storage capacity OSC and detects the deterioration state of the exhaust gas purifying catalyst on the basis of the calculation. For example, in the catalyst deterioration detecting apparatus described in Japanese Laid-Open Patent Publication No. 2004-176615, as the sensor in the downstream side of the exhaust gas purifying catalyst, a sensor (an oxygen sensor) is employed that outputs largely different signals in the case that a concentration of the oxygen in the exhaust gas comes to a value at a time when the air-fuel ratio of the air-fuel mixture is richer than a stoichiometric air-fuel ratio, and the case that it comes to a value at a time when the air-fuel ratio is lean.

Further, in the catalyst deterioration detecting apparatus mentioned above, each time when the output of the oxygen sensor is changed to a value corresponding to a rich air-fuel ratio from a value corresponding to a lean air-fuel ratio or vice versa (hereinafter, these changes are called an inversion), a control (an active air-fuel ratio control) for forcibly and largely changing the target air-fuel ratio of the air-fuel mixture is executed. The target air-fuel ratio of change includes a value leaner than the stoichiometric air-fuel ratio by a predetermined value (a lean air-fuel ratio), and a value richer than the stoichiometric air-fuel ratio by a predetermined value (a rich air-fuel ratio). In this control, in the case that the output of the oxygen sensor is changed to a value corresponding to a lean air-fuel ratio from a value corresponding to a rich air-fuel ratio, the target air-fuel ratio is changed to a rich air-fuel ratio from a lean air-fuel ratio. Further, in the case that the output of the oxygen sensor is changed to a value corresponding to a rich air-fuel ratio from a value corresponding to a lean air fuel ratio, the target air-fuel ratio is changed to a lean air-fuel ratio from a rich air-fuel ratio.

Further, if all of the oxygen stored in the exhaust gas purifying catalyst is consumed, the output of the oxygen sensor is inversed to a value corresponding to a rich air-fuel ratio from a value corresponding to a lean air-fuel ratio. In contrast, if oxygen is stored in the exhaust gas purifying catalyst at a full of the oxygen storage capacity OSC, the output is inverted to a value corresponding to a lean air-fuel ratio from a value corresponding to a rich air-fuel ratio. Accordingly, the oxygen storage capacity OSC is calculated by integrating the amount of oxygen stored in the exhaust gas purifying catalyst during a period that the output of the oxygen sensor is inverted to a value corresponding to a lean air-fuel ratio after being inverted to a value corresponding to a rich air-fuel ratio, or integrating the amount of oxygen released from the exhaust gas purifying catalyst during a period that the output is inverted to a value corresponding to a rich air-fuel ratio after being inverted to a value corresponding to a lean air-fuel ratio. As mentioned above, the oxygen storage capacity OSC of the exhaust gas purifying catalyst is calculated by integrating the amount of oxygen while setting the time point when the output of the oxygen sensor is inverted in correspondence to the execution of the active air-fuel ratio control to a start point and an end point. Further, the oxygen storage capacity OSC and a predetermined determination value are compared, and in the case that the oxygen storage capacity OSC is less than the determination value, an abnormality is determined by setting the phenomenon to be caused by the deterioration of the exhaust gas purifying catalyst.

A vehicle is provided with a driven body driven on the basis of a torque of an output shaft of the internal combustion engine, in addition to the internal combustion engine. For example, a transmission is one of such driven bodies. Further, between the internal combustion engine and a driven body, an engaging portion is provided that is rotated together with the output shaft, and is brought into contact with an engaged portion in the driven body so as to transmit a torque. The engaging portion and the engaged portion are essential for transmitting the rotation of the output shaft to the driven body. Further, it is desirable to set no gap in a rotating direction of the engaging portion between the engaging portion and the engaged portion. However, since the engaging portion and the engaged portion are manufactured in accordance with a machine work, it is hard to do away with the gap.

Accordingly, if the active air-fuel ratio control is executed by the catalyst deterioration detecting apparatus, there is a risk that the following problems are generated in the engaging portion and the engaged portion at a time when the target air-fuel ratio is inverted in correspondence to the inverse of the output of the oxygen sensor. In other words, the target air-fuel ratio is suddenly changed at a time of the inversion, the fuel injection amount is largely changed in accordance with the change, whereby the rotating speed of the output shaft of the internal combustion engine is increased (accelerated) or decreased (decelerated), and the torque transmitted to the driven body (the transmission) from the output shaft is fluctuated. If the torque fluctuation at this time exceeds an allowable maximum fluctuation amount, an accelerating degree and a decelerating degree of the rotation of the output shaft are enlarged. The engaging portion is relatively rotated with respect to the engaged portion, and is disconnected from and brought into contact with the engaged portion. An abnormal noise and a vibration are generated in accordance with the contact and estrangement, and there is a risk that a deterioration of a drivability of the vehicle is caused.

As a countermeasure against such a problem, the active air-fuel ratio control may be inhibited. However, this configuration reduces the opportunities of calculating the oxygen storage capacity OSC and detecting the deterioration of the exhaust gas purifying catalyst using the calculation in accordance with the inhibition of the active air-fuel ratio control.

### DISCLOSURE OF THE INVENTION

Accordingly, it is an objective of the present invention to provide a catalyst deterioration detecting apparatus of a vehicle internal combustion engine which can suppress a deterioration of a drivability while ensuring opportunities of detecting a deterioration of an exhaust gas purifying catalyst.

To achieve the foregoing and other objectives, and in accordance a first aspect of the present invention, a catalyst deterioration detecting apparatus of a vehicle internal combustion engine is provided. The engine executes fuel injection in such manner that an air-fuel ratio of mixture of intake air and fuel agrees with a target air-fuel ratio, and purifies exhaust gas generated in combustion of the air-fuel mixture, using an exhaust gas purifying catalyst that stores or releases oxygen. The vehicle includes a driven body that is driven by torque of an output shaft of the engine, and an engaging portion provided between the engine and the driven body. The engaging portion is contactable with the driven body to transmit the torque of the output shaft to the driven body. The apparatus includes an oxygen sensor, a control section, a determining section, and a limiting section. The oxygen sensor detects a concentration of oxygen of the exhaust gas at the downstream side of the exhaust gas purifying catalyst. The concentration of oxygen in the exhaust gas correlates to the air-fuel ratio of the air-fuel mixture. The oxygen sensor outputs a first signal indicating that the air-fuel ratio of the air-fuel mixture is leaner than a stoichiometric air-fuel ratio, and a second signal indicating that the air-fuel ratio of the air-fuel mixture is richer than the stoichiometric air-fuel ratio. The control section executes active air-fuel ratio control. In the active air-fuel ratio control, the control section changes the target air-fuel ratio from a lean air-fuel ratio, which is leaner than the stoichiometric air-fuel ratio, to a rich air-fuel ratio, which is richer than the stoichiometric air-fuel ratio, on the condition that the signal output from the oxygen sensor is changed from the second signal to the first signal. The control section changes the target air-fuel ratio from the rich air-fuel ratio to the lean air-fuel ratio on the condition that the signal output from the oxygen sensor is changed from the first signal to the second signal. During the execution of the active air-fuel ratio control, the determining section integrates the amount of oxygen that is stored in or released from the exhaust gas purifying catalyst from when the signal output from the oxygen sensor is changed until when the signal is changed subsequently, thereby calculating an oxygen storage capacity. The determining section uses the calculated oxygen storage capacity to determine a deterioration state of the exhaust gas purifying catalyst. The limiting section sets, as an allowable change amount, a change amount of the air-fuel ratio that corresponds to an allowable maximum fluctuation amount of the torque of the output shaft. The allowable change amount is varied according to the amount of the intake air. The limiting section limits a change of the target-air fuel ratio such that a change amount of the target air-fuel ratio due to a change of the signal output from the oxygen sensor does not exceed the allowable change amount.

In accordance a second aspect of the present invention, another catalyst deterioration detecting apparatus of a vehicle internal combustion engine is provided. The engine executes fuel injection in such manner that an air-fuel ratio of mixture of intake air and fuel agrees with a target air-fuel ratio, and purifies exhaust gas generated in combustion of the air-fuel mixture, using an exhaust gas purifying catalyst that stores or releases oxygen. The vehicle includes a driven body that is driven by torque of an output shaft of the engine, and an engaging portion provided between the engine and the driven body. The engaging portion is contactable with the driven body to transmit the torque of the output shaft to the driven body. The apparatus includes an oxygen sensor, a control section, a determining section, and a limiting section. The oxygen sensor detects a concentration of oxygen of the exhaust gas at the downstream side of the exhaust gas purifying catalyst. The concentration of oxygen in the exhaust gas correlates to the air-fuel ratio of the air-fuel mixture. The oxygen sensor outputs a first signal indicating that the air-fuel ratio of the air-fuel mixture is leaner than a stoichiometric air-fuel ratio, and a second signal indicating that the air-fuel ratio of the air-fuel mixture is richer than the stoichiometric air-fuel ratio. The control section executes active air-fuel ratio control. In the active air-fuel ratio control, the control section changes the target air-fuel ratio from a lean air-fuel ratio, which is leaner than the stoichiometric air-fuel ratio, to a rich air-fuel ratio, which is richer than the stoichiometric air-fuel ratio, on the condition that the signal output from the oxygen sensor is changed from the second signal to the first signal. The control section changes the target air-fuel ratio from the rich air-fuel ratio to the lean air-fuel ratio on the condition that the signal output from the oxygen sensor is changed from the first signal to the second signal. During the execution of the active air-fuel ratio control, the determining section integrates the amount of oxygen that is stored in or released from the exhaust gas purifying catalyst from when the signal output from the oxygen sensor is changed until when the signal is changed subsequently, thereby calculating an oxygen storage capacity. The determining section uses the calculated oxygen storage capacity to determine a deterioration state of the exhaust gas purifying catalyst. The limiting section sets, as an allowable change amount, a change amount of fuel injection that corresponds to an allowable maximum fluctuation amount of the torque of the output shaft. The allowable change amount is varied according to the amount of the intake air. The limiting section limits a change of the fuel injection amount such that a change amount of the target air-fuel ratio due to a change of the signal output from the oxygen sensor does not exceed the allowable change amount.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic view showing a structure of a catalyst deterioration detecting apparatus of a vehicle internal combustion engine according to a first embodiment of the present invention;

FIG. 2 is a schematic plan view showing the layout of an internal combustion engine and a driven body in a vehicle;

FIGS. 3A and 3B are partial cross sectional views showing a mating portion between an engaging portion and an engaged portion;

FIG. 4 is a flowchart showing a basic process of an active air-fuel ratio control routine;

FIG. 5 is a characteristic view showing a corresponding relation between an intake air amount GA and an allowable change amount A of an air-fuel ratio;

FIG. 6 is a timing chart showing changes of each of a target air-fuel ratio, an oxygen storage state, and an oxygen storage amount OSA in correspondence to a change of an output of an oxygen sensor, with regard to a case that the active air-fuel ratio control routine in FIG. 4 is executed;

FIG. 7 is a flowchart showing a catalyst deterioration detecting routine;

FIG. 8 is a flowchart showing an active air-fuel ratio control routine;

FIG. 9 is a timing chart showing changes of each of a target air-fuel ratio, an intake air amount GA, an allowable change amount A, an oxygen storage state, and an oxygen storage amount OSA in correspondence to a change of an output of an oxygen sensor, with regard to a case that the active air-fuel ratio control routine in FIG. 8 and the catalyst deterioration detecting routine in FIG. 7 are executed;

FIG. 10 is a flowchart showing an active air-fuel ratio control routine in accordance with a second embodiment of the present invention; and

FIG. 11 is a timing chart showing changes of each of a target air-fuel ratio, an intake air amount GA, an allowable change amount A, an oxygen storage state, and an oxygen storage amount OSA in correspondence to a change of an output of an oxygen sensor, with regard to a case that the active air-fuel ratio control routine in FIG. 10 and the catalyst deterioration detecting routine in FIG. 7 are executed.

### BEST MODE FOR CARRYING OUT THE INVENTION

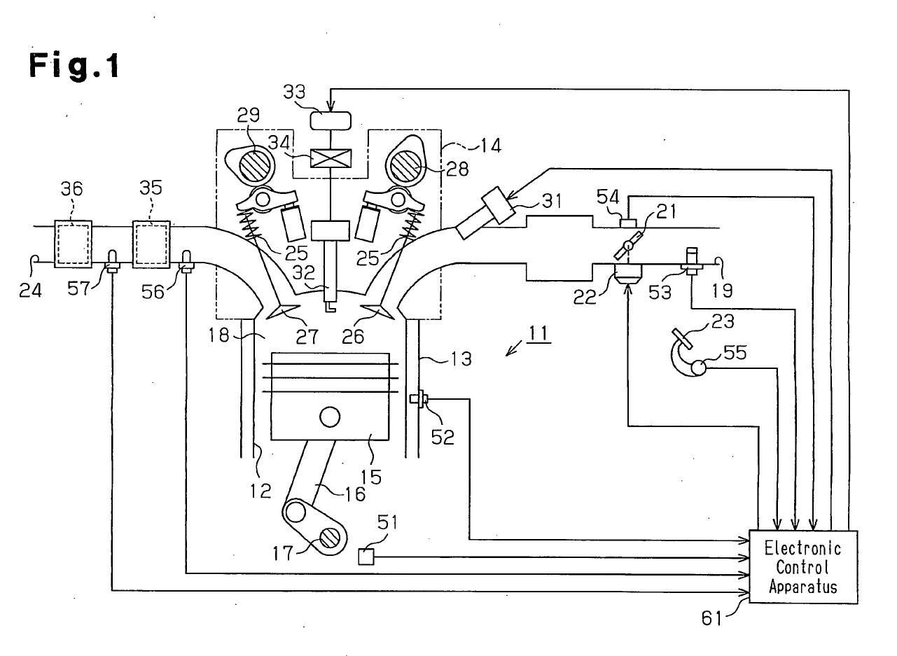

A description will be given of a first embodiment of the present invention with reference to FIGS. 1 to 9.

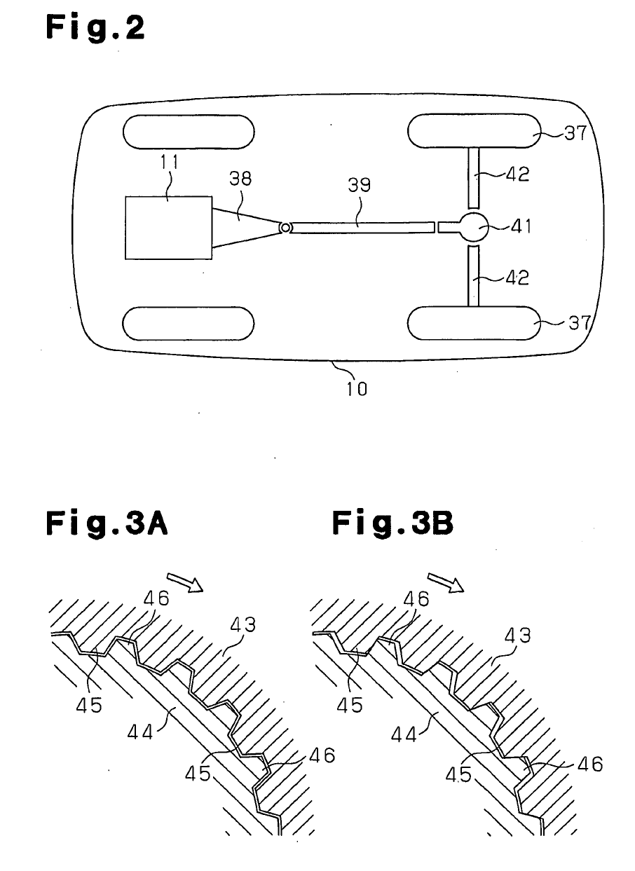

As shown in FIG. 2, an internal combustion engine 11, which is a gasoline engine, is mounted as a power source in a vehicle 10. As shown in FIG. 1, the internal combustion engine 11 is provided with a cylinder block 13 having a plurality of cylinders 12, and a cylinder head 14 mounted thereon. A piston 15 accommodated in each of the cylinders 12 is coupled to a crankshaft 17 corresponding to an output shaft of the internal combustion engine 11 via a connecting rod 16.

To a combustion chamber 18 in each of the cylinders 12 is connected an intake passage 19 for introducing air from the outside of the internal combustion engine 11 to the combustion chamber 18. A throttle valve 21 is pivotally provided in such a manner as to be rotated in the intake passage 19. An actuator 22 coupled to the throttle valve 21 is activated in correspondence to a pedaling operation of an accelerator pedal 23 by a driver, and pivots the throttle valve 21. The amount of air (an intake air amount GA) flowing through the intake passage 19 is changed in correspondence to a pivot angle (a throttle opening degree) of the throttle valve 21. Further, to the combustion chamber 18 in each of the cylinders 12 is connected an exhaust passage 24 for discharging a combustion gas generated in the combustion chamber 18 to the outside of the internal combustion engine 11.

The cylinder head 14 is provided with an intake valve 26 and an exhaust valve 27 each of which is urged by a valve spring 25, in each of the cylinders 12. The intake valve 26 is pushed down by an intake cam shaft 28 rotationally driven by the crankshaft 17, and opens and closes an opening portion in each of the cylinders 12 of the intake passage 19. Further, the exhaust valve 27 is pushed down by an exhaust cam shaft 29 rotationally driven by the crankshaft 17, and opens and closes an opening portion of the exhaust passage 24 in each of the cylinders 12.

To the intake passage 19, a fuel injection valve 31 is attached in correspondence to each of the cylinders 12. A fuel injected from the fuel injection valve 31 is mixed with the intake air passing through the intake passage 19 so as to form an air-fuel mixture. The structure may be made such that the fuel is directly injected into the combustion chamber 18 in each of the cylinders 12 from the fuel injection valve 31.

An ignition plug 32 attached to the cylinder head 14 in each of the cylinders 12 is connected to an igniter 33 via an ignition coil 34. A high voltage output from the ignition coil 34 on the basis of an ignition signal from the igniter 33 is applied to each of the ignition plugs 32. Further, the air-fuel mixture is ignited by a spark discharge of the ignition plug 32 and burnt. Each piston 15 is reciprocated by a high-temperature and high-pressure combustion gas generated at this time. A reciprocating motion of the pistons 15 is transmitted to the crankshaft 17 via the connecting rods 16, and the crankshaft 17 is rotated, whereby a driving force (torque) of the internal combustion engine 11 is obtained.

In the exhaust passage 24 are arranged in series a plurality of catalysts that achieve an exhaust gas purifying function when reaching a predetermined activation temperature after starting of the internal combustion engine 11. In the present embodiment, the following catalysts are employed: a catalyst (hereinafter, refer to as an upstream catalyst) 35 which is arranged in a downstream side of the internal combustion engine, and mainly aims at an improvement of an exhaust emission immediately after starting the internal combustion engine 11 and in a warm-up process; and a catalyst (hereinafter, refer to as a downstream catalyst) 36 which is arranged in a downstream side of the catalyst 35, and mainly aims at an improvement of an exhaust emission at a time of a normal operation.

Each of the upstream catalyst 35 and the downstream catalyst 36 has an oxygen storage capacity OSC, and stores oxygen within a range of the capacity. These catalysts 35 and 36 oxidize unburned combustible contents by releasing the stored oxygen, in the case that the unburned combustible contents such as hydro carbon (HC), carbon monoxide (CO) and the like are contained in the exhaust gas. Further, the catalysts 35 and 36 reduce the contents mentioned above by storing surplus oxygen, in the case that oxygen, nitrogen oxide (NOx) and the like are much contained in the exhaust gas, thereby keeping an ambient atmosphere in the inner portions of the catalysts 35 and 36 in a stoichiometric air-fuel ratio. Both of the catalysts 35 and 36 purify the exhaust gas on the basis of the principles mentioned above, respectively.

As shown in FIG. 2, between the internal combustion engine 11 and a drive wheel 37 are provided a transmission 38, a propeller shaft 39, a differential 41, a pair of axle shafts 42 and the like. The transmission 38 converts a rotating speed, a torque and the like of the crankshaft 17, for example, by changing a combination (a shift stage) of gears having different teeth numbers. In accordance with this conversion, a change gear ratio corresponding to a rotating speed ratio between an input shaft and an output shaft (none of which is not illustrated) of the transmission 38 corresponds to the combination of the gears. The propeller shaft 39 is a shaft transmitting the rotation of the output shaft of the transmission 38 to the differential 41. The differential 41 is a differential gear dividedly transmitting a power from the propeller shaft 39 to both the axle shafts 42. Each of the axle shafts 42 is a shaft transmitting the power divided by the differential 41 to the drive wheel 37.

The transmission 38, the propeller shaft 39, the differential 41, the axle shaft 42 and the like between the internal combustion engine 11 and the drive wheel 37 correspond to a driven body which is actuated on the basis of the transmission of the torque of the crankshaft 17. An engaging portion 43 and an engaged portion 44 shown in FIGS. 3A and 3B are provided in a torque transmission path between the crankshaft 17 and the predetermined driven body, for example, the path between the transmission 38. Arrows in FIGS. 3A and 3B show a rotating direction of the engaging portion 43. The engaging portion 43 is provided in the crankshaft 17 in such a manner as to be integrally rotatable, and the engaged portion 44 is provided in an input shaft of the transmission 38 in such a manner as to be integrally rotatable. A plurality of teeth 45 and 46 each extending in an axial direction (a direction orthogonal to a paper surface) are respectively formed in an inner peripheral surface of the engaging portion 43 and an outer peripheral surface of the engaged portion 44. The engaging portion 43 is put on an outer side of the engaged portion 44 in such a manner that each of the teeth 45 of the engaging portion 43 is positioned between the adjacent teeth 46 of the engaged portion 44. Further, the rotation of the engaging portion 43 is transmitted to the engaged portion 44 through a mating portion between the teeth 45 and 46, whereby the engaged portion 44 is rotationally driven. In this case, the structure may be made such that the engaging portion 43 is arranged in an inner side of the engaged portion 44, whereby the teeth 45 and 46 are mated.

As shown in FIG. 1, in order to detect a state of each of the portions of the vehicle 10 including an operation state of the internal combustion engine 11, various sensors are provided in the vehicle 10. As these sensors, the present embodiment employs a crank angle sensor 51, a water temperature sensor 52, an air flowmeter 53, a throttle sensor 54, an accelerator sensor 55, an air-fuel ratio sensor 56, an oxygen sensor 57 and the like.

The crank angle sensor 51 generates a pulsed signal every time when the crankshaft 17 is rotated at a fixed angle. This signal is used for calculating a crank angle corresponding to a rotating angle of the crankshaft 17, and an engine speed corresponding to a rotating speed of the crankshaft 17 per unit of time. The water temperature sensor 52 detects a temperature of a cooling water flowing through an inner portion of the internal combustion engine 11, and the air flowmeter 53 detects an amount of air (an intake air amount GA) flowing through the intake passage 19. The throttle sensor 54 detects a throttle opening degree of the throttle valve 21, and the accelerator sensor 55 detects a pedaling amount of the accelerator pedal 23.

The air-fuel ratio sensor 56 is arranged in an upstream side of the upstream catalyst 35, and outputs a signal corresponding to a concentration of the oxygen in the exhaust gas which has a close connection to the air-fuel ratio A/F of the air-fuel mixture. An output current of the air-fuel ratio sensor 56 comes to “0”, for example, in the case that the air-fuel ratio A/F of the air-fuel mixture is a stoichiometric air-fuel ratio. Further, the output current becomes larger in a negative direction in accordance that the air-fuel ratio A/F of the air-fuel mixture becomes rich. Contrastingly, the output current becomes larger in a positive direction in accordance that the air-fuel ratio A/F becomes lean. Accordingly, it is possible to detect a lean degree and a rich degree of the air-fuel ratio A/F of the air-fuel mixture on the basis of the output signal of the air-fuel ratio sensor 56.

The oxygen sensor 57 is arranged between the upstream catalyst 35 and the downstream catalyst 36 in the exhaust passage 24, and outputs signals corresponding to the concentration of the oxygen in the exhaust gas in the downstream side of the upstream catalyst 35. An output signal having a voltage of approximately zero volts, or a first signal, is obtained from the oxygen sensor 57 in the case that the concentration of the oxygen in the exhaust gas is the concentration at a time when the air-fuel ratio A/F of the air-fuel mixture is leaner than the stoichiometric air-fuel ratio, and a output signal having a voltage of approximately one volt, a second signal, is obtained in the case that the air-fuel ratio A/F of the air-fuel mixture is richer than the stoichiometric air-fuel ratio. Further, the output voltage of the oxygen sensor 57 is largely changed in the case that the concentration of the oxygen in the exhaust gas is the concentration at a time when the air-fuel ratio A/F of the air-fuel mixture is close to the stoichiometric air-fuel ratio. As mentioned above, the oxygen sensor 57 outputs the largely different signals in the case that the air-fuel ratio A/F of the air-fuel mixture is lean and rich with respect to the stoichiometric air-fuel ratio. Accordingly, it is possible to detect whether the exhaust gas in the downstream side of the upstream catalyst 35 is in the state corresponding to a lean air-fuel ratio or the state corresponding to a rich air-fuel ratio, on the basis of the output signal of the oxygen sensor 57.

The vehicle 10 is provided with an electronic control apparatus 61 controlling each of the portions of the internal combustion engine 11 or the like, on the basis of the various signals of the sensors 51 to 57 mentioned above. The electronic control apparatus 61 is structured centering on a micro computer, and a central processing unit (CPU) executes computing processes in accordance with control programs, initial data, control maps and the like which are stored in a read only memory (ROM), and executes various controls relating to operation of the internal combustion engine 11 and traveling of the vehicle 10. Results of computation by the CPU are temporarily stored in a random access memory (RAM).

As the control executed by the electronic control apparatus 61, there can be listed up, for example, a drive control (a throttle control) of the actuator 22, a drive control (a fuel injection control) of the fuel injection valve 31, a drive control (an ignition timing control) of the ignition plug 32, and the like. The electronic control apparatus 61 calculates a control target value (a target throttle opening degree) of the throttle opening degree on the basis of the pedaling amount of the accelerator pedal 23 by the accelerator sensor 55 and the engine speed by the crank angle sensor 51, for example, at a time of the throttle control. Further, the electronic control apparatus 61 controls the operation of the actuator 22 in such a manner that an actual throttle opening degree by the throttle sensor 54 agrees with the target throttle opening degree.

Further, in the fuel injection control, the target injection amount for conforming the air-fuel ratio A/F of the air-fuel mixture to the control target value (the target air-fuel ratio) is calculated on the basis of the intake air amount GA regulated through the throttle control mentioned above. The target injection amount is corrected on the basis of the signals from the sensors. For example, the target injection amount is corrected so as to be increased or decreased in such a manner that the actual air-fuel ratio A/F of the air-fuel mixture detected by the air-fuel ratio sensor 56 agrees with the target air-fuel ratio mentioned above. Further, the target injection amount is corrected so as to be increased or decreased on the basis of the output signal of the oxygen sensor 57, that is, the oxygen storage state and the oxygen release state of the upstream catalyst 35. Further, the fuel injection valve 31 is excited for a time corresponding to the corrected target injection amount. The fuel injection valve 31 is opened on the basis of this current application, and the fuel is injected at an amount corresponding to the corrected target injection amount.

Further, in the ignition timing control, the ignition plug 32 is ignited by calculating the control target value (the target ignition timing) of the ignition timing on the basis of the throttle opening degree by the throttle sensor 54 and the engine speed by the crank angle sensor 51, and controlling the igniter 33. The air-fuel mixture mentioned above is ignited by the spark discharge in accordance with the ignition of the ignition plug 32 so as to be burned.

The exhaust gas discharged from the internal combustion engine 11 is discharged to the atmospheric air after passing through the upstream catalyst 35 and the downstream catalyst 36. Accordingly, in order to maintain a desired emission characteristic, it is necessary that both the catalysts 35 and 36 have a proper oxygen storage capacity OSC. A corresponding relation is seen between the oxygen storage capacity OSC of each of the catalysts 35 and 36 and the deteriorated state, and there is a tendency that the oxygen storage capacity OSC is reduced in accordance that the deterioration of each of the catalysts 35 and 36 is promoted.

Accordingly, the electronic control apparatus 61 is structured such as to determine the oxygen storage capacity OSC of each of the catalysts 35 and 36 in addition to the throttle control, the fuel injection control, the ignition timing control and the like mentioned above, and detect the abnormality (the deterioration) of each of the catalysts 35 and 36 on the basis of the determination. In other words, the deterioration state is detected by determining whether or not the upstream catalyst 35 has the proper oxygen storage capacity OSC. A description will be given of the calculation of the oxygen storage capacity OSC and the deterioration detection by aiming at the upstream catalyst 35. The calculation of the oxygen storage capacity OSC is executed on the assumption that the active air-fuel ratio control is executed.

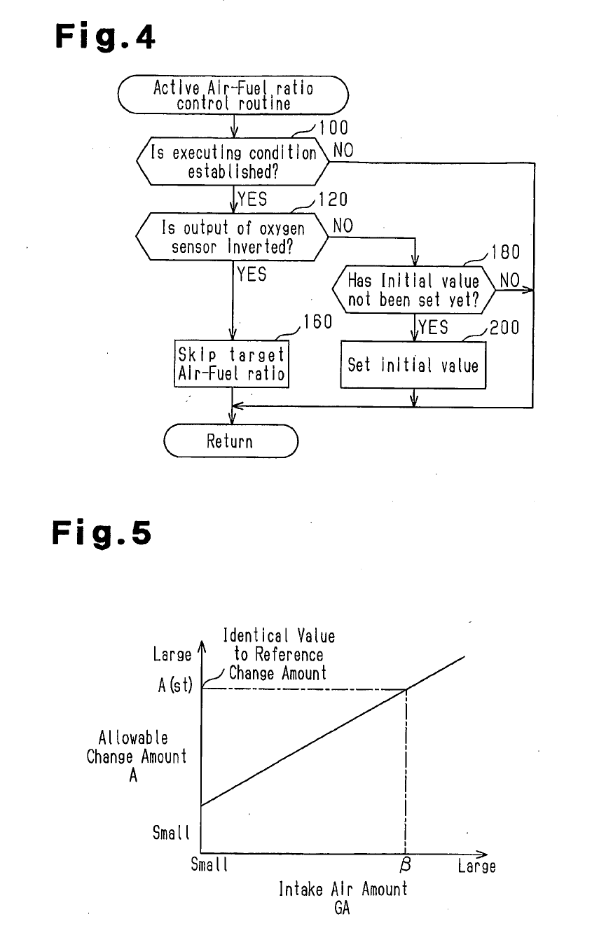

A flowchart in FIG. 4 shows only a basic process with respect to the active air-fuel ratio control. These processes are the same as the process which the catalyst deterioration detecting apparatus in the Japanese Laid-Open Patent Publication No. 2004-176615 mentioned above executes in the active air-fuel ratio control. The active air-fuel ratio control routine is repeatedly executed per predetermined time by the electronic control apparatus 61.

In step 100, the electronic control apparatus 61 determines whether or not a condition (an execution condition) for executing the active air-fuel ratio control is established. In this case, the execution condition includes for example, a condition that the temperature of the upstream catalyst 35 reaches an active temperature and the like. If the determination condition is not satisfied (the execution condition is not established), the active air-fuel ratio control routine is temporarily finished.

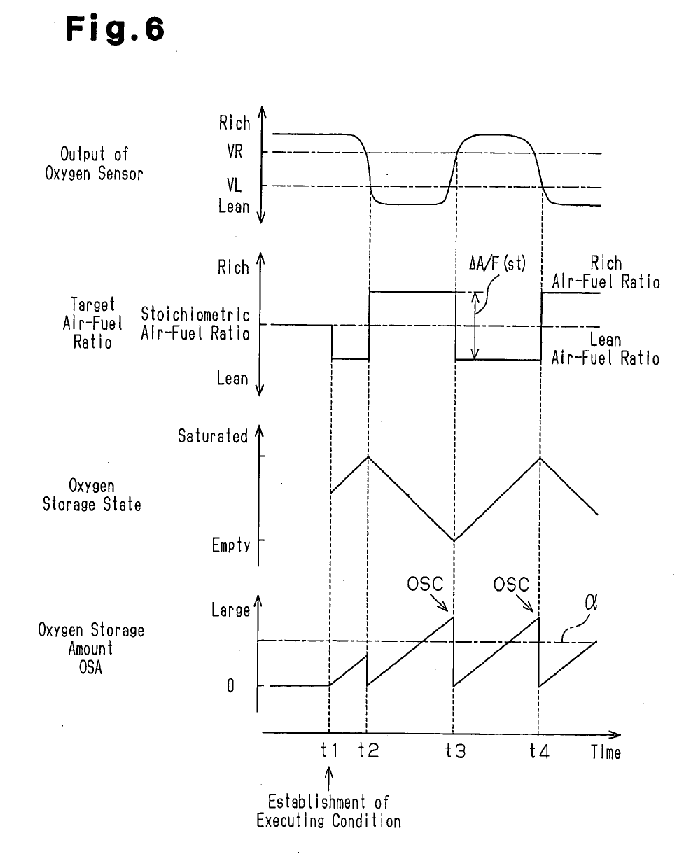

In contrast, if the determination condition in step 100 is satisfied (the execution condition is established), it is determined at step 120 whether or not the output of the oxygen sensor 57 is inverted to a value corresponding to a lean air-fuel ratio from a value corresponding to a rich air-fuel ratio, or whether or not the output is inverted to a value corresponding to a rich air-fuel ratio from a value corresponding to a lean air-fuel ratio, in the period from the previous control cycle to the present control cycle. Two determination values (a lean determination value VL and a rich determination value VR) shown in FIG. 6 are employed for this determination. If the output of the oxygen sensor 57 exceeds the rich determination value VR, in other words, the output is changed (inverted) to a value corresponding to a rich air-fuel ratio, or the second signal from a value corresponding to a lean air-fuel ratio, or the first signal, it is determined that the exhaust gas in the downstream side of the upstream catalyst 35 is changed to the nature corresponding to the air-fuel mixture in which the air-fuel ratio A/F is rich. On the other hand, if the output of the oxygen sensor 57 is below the lean determination value VL, in other words, the output is changed (inverted) to a value corresponding to a lean air-fuel ratio, or the first signal from a value corresponding to a rich air-fuel ratio, or the second signal, it is determined that the exhaust gas in the downstream side of the upstream catalyst 35 is changed to the nature corresponding to the air-fuel mixture in which the air-fuel ratio A/F is lean.

If the determination condition in step 120 in FIG. 4 mentioned above is not satisfied (the inversion is not generated), in step 180, it is determined whether or not the initial value of the target air-fuel ratio has not been set after the execution condition of step 100 mentioned above is established from a non-established state. If the determination condition is satisfied (the initial value has not been set yet), the initial value of the target air-fuel ratio is set at step 200 on the basis of the output of the oxygen sensor 57 at that time. In this case, two values (a rich air-fuel ratio and a lean air-fuel ratio) are previously prepared as the initial value, and the value having the opposite tendency to the output of the oxygen sensor 57 is selected. Specifically, if the output of the oxygen sensor 57 is a value corresponding to a rich air-fuel ratio, the second signal, a lean air-fuel ratio is selected. If the output of the oxygen sensor 57 is a value corresponding to a lean air-fuel ratio, the first signal, a rich air-fuel ratio is selected. Further, the selected value is set as the initial value of the target air-fuel ratio. As a case in which the process of step 200 mentioned above is executed, there can be listed up a case in which the execution condition of step 100 is switched to a state where the condition is satisfied from a state that the condition is not satisfied. In this case, the target air-fuel ratio has not set yet, and the target air-fuel ratio is first set in accordance with the process of step 200 mentioned above. After the process of step 200, the active air-fuel ratio control routine is temporarily finished.

In contrast, if the determination condition of step 180 mentioned above is not satisfied (the initial value has been already set), the active air-fuel ratio control routine is temporarily finished without executing the process of step 200 mentioned above. In this case, the value (a rich air-fuel ratio or a lean air-fuel ratio) having been set in the previous control cycle is maintained as the target air-fuel ratio.

On the other hand, if the determination condition of step 120 mentioned above is satisfied (the inverse is generated), the process proceeds to step 160, and a process for largely changing (skipping) the target air-fuel ratio between a rich air-fuel ratio and a lean air-fuel ratio is executed. For example, if the previous value of the target air-fuel ratio is a rich air-fuel ratio, the ratio is changed to a lean air-fuel ratio, and vice versa. If the previous value is a lean air-fuel ratio, the ratio is changed to a rich air-fuel ratio. Further, the active air-fuel ratio control routine is temporarily finished after the process of step 160. As mentioned above, in the active air-fuel ratio control routine, the target air-fuel ratio is changed every time when the output of the oxygen sensor 57 is inversed, under the state in which the execution condition is established.

If the target air-fuel ratio is calculated and set as mentioned above, the target injection amount is corrected so as to be increased and decreased in accordance with an additional routine in such a manner that the actual air-fuel ratio A/F agrees with the changed target air-fuel ratio. Further, the current application to the fuel injection valve 31 is controlled on the basis of the corrected target injection amount, and the corresponding amount of fuel is injected from the fuel injection valve 31.

In the active air-fuel ratio control routine in FIG. 4 mentioned above, the processes in steps 100, 120 and 160 to 200 executed by the electronic control apparatus 61 correspond to the processes executed by the control section.

In accordance with the active air-fuel ratio control routine mentioned above, the target air-fuel ratio and the oxygen storage state of the upstream catalyst 35 are changed, for example, as shown in FIG. 6, in correspondence to a change of the output of the oxygen sensor 57. This example shows a case that the execution condition of the active air-fuel ratio control is established at a time t1, the output of the oxygen sensor 57 is inversed to a value corresponding to a lean air-fuel ratio from a value corresponding to a rich air-fuel ratio at time t2 and time t4, and the output of the oxygen sensor 57 is inversed to a value corresponding to a rich air-fuel ratio from a value corresponding to a lean air-fuel ratio at a time t3.

If the execution condition is established at the time t1 (YES in step 100), the process is executed in the order of step 100, step 120, step 180, step 200, and is then returned in the active air-fuel ratio control routine in FIG. 4, and a lean air-fuel ratio is set as the initial value of the target air-fuel ratio, because the oxygen sensor 57 at this time outputs a value corresponding to a rich air-fuel ratio and is not inversed. Since the target injection amount is corrected in such a manner that the actual air-fuel ratio A/F agrees with a lean air-fuel ratio, the exhaust gas corresponding to the air-fuel mixture which includes the oxygen and has a lean air-fuel ratio flows into the upstream catalyst 35. Accordingly, the upstream catalyst 35 stores the surplus oxygen in the exhaust gas.

Since both of the determination conditions of steps 120 and 180 are not satisfied during the period that the oxygen sensor 57 outputs the value corresponding to a rich air-fuel ratio after the time t1, the process is executed in the order of step 100, step 120, step 180, and is then returned, and a lean air-fuel ratio corresponding to the previous value is maintained as the target air-fuel ratio. The upstream catalyst 35 keeps storing the oxygen in the exhaust gas within the range of the oxygen storage capacity. Accordingly, the oxygen storage amount in the upstream catalyst 35 is increased. If the maximum oxygen storage capacity of oxygen is stored in the upstream catalyst 35 and the upstream catalyst 35 is in a saturated state, the exhaust gas corresponding to the air-fuel mixture which includes the oxygen and has a lean air-fuel ratio starts flowing out to the downstream side of the upstream catalyst 35. In accordance with this, the output of the oxygen sensor 57 is made leaner. If the output of the oxygen sensor 57 is below the lean determination value VL at the time t2, and is changed (inverted) to a value corresponding to a lean air-fuel ratio from a value corresponding to a rich air-fuel ratio, the determination condition of step 120 is satisfied, and the process is executed in the order of step 100, step 120, step 160, and is then returned. The target air-fuel ratio is changed to a rich air-fuel ratio from a lean air-fuel ratio in accordance with the process of step 160 at this time. The rich air-fuel ratio is maintained during the period that the output of the oxygen sensor 57 is a value corresponding to a lean air-fuel ratio after the time t2. The upstream catalyst 35 releases the stored oxygen so as to oxidize the unburned combustible components (HC, CO) in the exhaust gas. Accordingly, the stored amount of the oxygen in the upstream catalyst 35 is reduced.

If the target air-fuel ratio is maintained at a rich air-fuel ratio, whereby all of the stored oxygen in the upstream catalyst 35 is consumed so as to be in an empty state, the exhaust gas corresponding to the air-fuel ratio which includes the unburned combustible content and has the rich air-fuel ratio thereafter starts flowing out to the downstream side of the upstream catalyst 35, and the output of the oxygen sensor 57 is made richer. The output of the oxygen sensor 57 exceeds the rich determination value VR at the time t3, and is changed (inverted) to a value corresponding to a rich air-fuel ratio from a value corresponding to a lean air-fuel ratio, the target air-fuel ratio is changed to a lean air-fuel ratio from a rich air-fuel ratio in accordance with the process of step 160. At this time, the upstream catalyst 35 comes to an empty state in which all the stored oxygen is released. In this state, if the exhaust gas corresponding to the air-fuel mixture which includes the oxygen and has a lean air-fuel ratio flows into the upstream catalyst 35 in accordance with the change of the target air-fuel ratio mentioned above, the upstream catalyst 35 stores the surplus oxygen in the exhaust gas.

The target air-fuel ratio is maintained at a lean air-fuel ratio during the period that the output of the oxygen sensor 57 is inverted to a value corresponding to a lean air-fuel ratio from a value corresponding to a rich air-fuel ratio. During this maintenance, the upstream catalyst 35 keeps storing the oxygen in the exhaust gas within the range of the oxygen storage capacity. Accordingly, the stored amount of the oxygen in the upstream catalyst 35 is going to be increased. Further, if the maximum oxygen storage capacity of oxygen is stored in the upstream catalyst 35 and the upstream catalyst 35 is in the saturated state, the exhaust gas corresponding to the air-fuel mixture which includes the oxygen and has a lean air-fuel ratio starts flowing out to the downstream side of the upstream catalyst 35. The output of the oxygen sensor 57 is below the lean determination value VL at the time t4, and is changed (inverted) to a value corresponding to a lean air-fuel ratio from a value corresponding to a rich air-fuel ratio. If the determination condition of step 120 is satisfied on the basis of the inversion, the target air-fuel ratio is again changed to a rich air-fuel ratio from a lean air-fuel ratio.

Thereafter, during the period that the execution condition (YES in step 100), the process for forcibly changing the target air-fuel ratio to a lean air-fuel ratio from a rich air-fuel ratio is repeatedly executed, or vice versa in correspondence to the inversion of the output of the oxygen sensor 57.

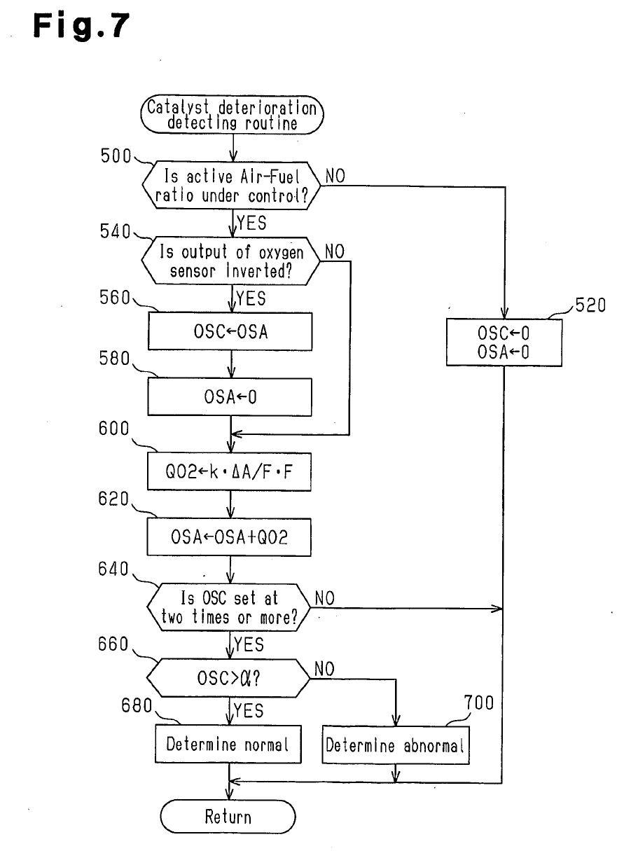

Next, a description will be given of a catalyst deterioration detecting routine detecting the deteriorated state of the upstream catalyst 35 on the assumption that the active air-fuel ratio control is executed, with reference to the flowchart in FIG. 7. The catalyst deterioration detecting routine is repeatedly executed every predetermined time by the electronic control apparatus 61.

During the active air-fuel ratio control, the output of the oxygen sensor 57 is inverted to the value corresponding to a rich air-fuel ratio from a value corresponding to a lean air-fuel ratio at a time point (refer to the time t3 in FIG. 6) when all of the stored oxygen within the upstream catalyst 35 is consumed so as to be in an empty state, as mentioned above. Further, the output is inverted to a value corresponding to a lean air-fuel ratio from a value corresponding to a rich air-fuel ratio at a time point (refer to the time t2 and time t4 in FIG. 6) when the upstream catalyst 35 stores the oxygen to the maximum of the oxygen storage capacity OSC so as to be in the saturated state. Accordingly, it is possible to determine the oxygen storage capacity OSC of the upstream catalyst 35 by integrating the amount of the excess oxygen in the exhaust gas flowing into the upstream catalyst 35 during the period (refer to the period between the time t3 and time t4 in FIG. 6) when the output of the oxygen sensor 57 is inverted again to a value corresponding to a lean air-fuel ratio after the time point when the output is inverted to the value corresponding to a rich air-fuel ratio from a value corresponding to a lean air-fuel ratio. In the same manner, it is possible to determine the oxygen storage capacity OSC of the upstream catalyst 35 by integrating the amount of the oxygen released from the upstream catalyst 35 during the period (refer to the period between the time t2 and time t3 in FIG. 6) when the output of the oxygen sensor 57 is inverted again to the value corresponding to a rich air-fuel ratio after the time point when the output is inverted to a value corresponding to a lean air-fuel ratio from a value corresponding to a rich air-fuel ratio.

The upstream catalyst 35 releases the oxygen in such a manner as to correct the shortfall of the oxygen, in the case that the air-fuel ratio A/F of the air-fuel mixture corresponding to the concentration of the oxygen in the exhaust gas is richer than a stoichiometric air-fuel ratio A/Fstoichi, that is, (A/F)<(A/Fstoichi). In this case, if the fuel supply amount to the internal combustion engine 11 is denoted as F, the amount of the lacking oxygen QO2 can be expressed by the following expression (1) by using the air-fuel ratio A/F and the stoichiometric air-fuel ratio A/Fstoichi. In this case, however, “k” denotes a coefficient k (about 0.23) indicating the rate of the oxygen contained in the intake air, in the expression (1).

$$\begin{matrix}QQ 2 = k \cdot \vert ( A / Fstoichi ) - ( A / F ) \vert \cdot F \\ = k \cdot Δ A / F \cdot F\end{matrix} \qquad ( 1 )$$

Further, the upstream catalyst 35 stores the excess amount of the oxygen in the case that the air-fuel ratio A/F is leaner than the stoichiometric air-fuel ratio A/Fstoichi, that is, (A/F)>(A/Fstoichi). In this case, if the fuel supply amount to the internal combustion engine 11 is denoted as F, the amount of the excess oxygen QO2 can be expressed by the expression (1) mentioned above in the same manner.

In this case, the air-fuel ratio A/F can be detected by the air-fuel ratio sensor 56. Further, since the electronic control apparatus 61 controls the fuel injection amount itself, it is possible to detect the fuel supply amount F per unit time. Accordingly, the electronic control apparatus 61 can calculate the lacking or excess oxygen amount QO2 per unit time by substituting the air-fuel ratio A/F and the fuel supply amount F in the expression (1) mentioned above. Further, the electronic control apparatus 61 can calculate the oxygen storage capacity OSC of the upstream catalyst 35 by integrating the oxygen amount QO2 by setting the inversion to the start point or the end point under the environment that the output of the oxygen sensor 57 is inverted in accordance with the execution of the active air-fuel ratio control.

On the basis of the point mentioned above, the electronic control apparatus 61 determines first in step 500 whether or not the active air-fuel ratio control is under execution, at a time of executing the catalyst deterioration detecting routine in FIG. 7. If the determination condition is not satisfied (if the active air-fuel ratio control is not executed), step 520 resets the oxygen storage capacity OSC to “0”, and the oxygen storage amount OSA corresponding to the integrated value of the oxygen amount QO2 is reset to “0”. The catalyst deterioration detecting routine is temporarily finished after the process in step 520.

In contrast, if the determination condition of step 500 is satisfied (if the active air-fuel ratio control is under execution), it is determined at step 540 whether or not the output of the oxygen sensor 57 is inverted during the period from the previous control cycle to the present control cycle. If the determination condition is not satisfied (the output inversion is not generated), a process (steps 600 and 620) for calculating the oxygen storage capacity OSC is executed. First, in step 600, the lacking or excess oxygen amount QO2 per unit time on the basis of the expression (1) mentioned above is calculated. Next, in step 620, the oxygen amount QO2 determined in step 600 to the oxygen storage amount OSA determined by integrating by the previous control cycle is added, and the result of addition is set as a new oxygen storage amount OSA so as to store in the memory (RAM).

If the determination condition of step 540 mentioned above is satisfied (if the output inversion is generated), in step 560, the oxygen storage amount OSA calculated at this time point is set as the oxygen storage capacity OSC of the upstream catalyst 35 so as to store in the memory (RAM). Further, in step 580, the oxygen storage amount OSA is set back to “0” (cleared). After the process of step 580, the process proceeds to step 600 mentioned above.

Therefore, in accordance with the process of steps 540 to 620, the oxygen storage amount OSA calculated every time when the output of the oxygen sensor 57 is inverted is set and stored as the oxygen storage capacity OSC of the upstream catalyst 35, and the calculation of the oxygen storage amount OSA is newly started.

Next, in step 640 executed after step 620 mentioned above, it is determined whether or not the oxygen storage capacity OSC is set and stored two times or more after starting the active air-fuel ratio control. If the determination condition is not satisfied, the catalyst deterioration detecting routine is temporarily finished. As a case in which the determination condition of step 640 is not satisfied, there can be listed up a case that the output of the oxygen sensor 57 has not inverted yet after starting the active air-fuel ratio control, and the oxygen storage capacity OSC has never been set and stored, and a case that the oxygen storage capacity OSC is calculated in correspondence to the first inversion of the output of the oxygen sensor 57. In the latter case, the oxygen storage capacity OSC is calculated, however, is not calculated from the time point when the output of the oxygen sensor 57 is inverted, that is, the time point when all of the stored oxygen within the upstream catalyst 35 is consumed, or the time when the upstream catalyst 35 stores the oxygen to the maximum of the oxygen storage capacity OSC. If the deterioration determination of the upstream catalyst 35 is executed on the basis of the oxygen storage capacity OSC, there is a risk that the erroneous determination is executed. Accordingly, in this case, the catalyst deterioration detecting routine is finished without executing the deterioration determination.

In contrast, if the determination condition of step 640 is satisfied, the deterioration state of the upstream catalyst 35 is determined in steps 660 to 700 on the basis of the oxygen storage capacity OSC stored in the memory (RAM) at the time point. The oxygen storage capacity OSC satisfying the determination condition of step 640 is calculated at two times or more after starting the active air-fuel ratio control, and is calculated over a period when the output of the oxygen sensor 57 is next inverted after the output is inverted.

The electronic control apparatus 61 determines in step 660 whether or not the oxygen storage capacity OSC stored in the memory (RAM) at this time point is larger than a previously set determination value α. In this case, the determination value α is set to an upper limit value or a value closer thereto in a range necessary for purifying the exhaust gas, in the oxygen storage capacity OSC. If the determination condition of step 660 is satisfied (OSC>α), it is determined at step 680 that the upstream catalyst 35 has a sufficient oxygen storage capacity OSC for purifying the exhaust gas, and is “normal”. In contrast, if the determination condition of step 660 is not satisfied (OSC≦α), it is determined at step 700 that the deterioration of the upstream catalyst 35 makes progress to a significant level, the oxygen storage capacity OSC is insufficient for reliably purifying the exhaust gas, and the upstream catalyst 35 is “abnormal”. Further, the catalyst deterioration detecting routine is finished after the process of step 680 or 700 mentioned above.

In the catalyst deterioration detecting routine in FIG. 7 mentioned above, the process of steps 500 to 700 executed by the electronic control apparatus 61 correspond to the process executed by the determining section.

In accordance with the catalyst deterioration detecting routine mentioned above, the oxygen storage amount OSA in the upstream catalyst 35 is changed, for example, as shown in FIG. 6, in correspondence to the change of the output of the oxygen sensor 57.

Since the active air-fuel ratio control is not executed in the period before the time t1 when the execution condition of the active air-fuel ratio control is established, the process is executed in the order of step 500, step 520, and is then returned, and both of the oxygen storage capacity OSC and the oxygen storage amount OSA are set to “0”.

If the execution condition is established at the time t1 and the active air-fuel ratio control is started, the process is executed in the order of step 500, step 540, step 600, step 620, step 640, and is then returned because a value corresponding to a rich air-fuel ratio is output from the oxygen sensor 57 at this time and is not inverted, and the oxygen storage capacity OSC has been never calculated. Each of the calculation of the oxygen amount QO2 (step 600) and the calculation and storage of the oxygen storage amount OSA (step 620) is executed.

The oxygen amount QO2 is integrated and the oxygen storage amount OSA is increased in accordance with the process of step 620, during the period after the time t1 and before the time t2 when the output of the oxygen sensor 57 is next inverted. If the output of the oxygen sensor 57 is inverted at the time t2, the determination condition of step 540 is satisfied. Further, the oxygen storage capacity OSC is calculated, however, it is the first time after starting the active air-fuel ratio control, and the determination condition of step 640 is not satisfied. Accordingly, the process is executed in the order of step 500, step 540, step 560, step 580, step 600, step 620, step 640, and is then returned. The oxygen storage amount OSA is reset to “0” in accordance with the process of step 580. The determination (steps 660 to 700) of the deterioration state of the upstream catalyst 35 is not executed on the basis of the oxygen storage capacity OSC.

The oxygen amount QO2 is integrated and the oxygen storage amount OSA is increased in accordance with the process of step 620 in the period after the time t2 and before the time t3 when the output of the oxygen sensor 57 is next inverted. If the output of the oxygen sensor 57 is inverted at the time t3, the determination condition of step 540 is satisfied. Further, the oxygen storage capacity OSC is set and stored, however, it is the second time or more after starting the active air-fuel ratio control, and the determination condition of step 640 is satisfied. Accordingly, the process is executed in the order of step 500, step 540, step 560, step 580, step 600, step 620, step 640, step 660, step 680 (or step 700), and is then returned. The oxygen storage amount OSA is reset to “0” in accordance with the process of step 580. The determination of the deterioration state of the upstream catalyst 35 is executed on the basis of the oxygen storage capacity OSC.

The oxygen storage amount OSA or the like is also changed in the period after the time t3 and before the time t4 when the output of the oxygen sensor 57 is next inverted, the same manner as the time t2 to time t3 mentioned above. The same matter is applied to the time t4 and after.

In the internal combustion engine 11 to which the transmission 38 is coupled via the engaging portion 43 and the engaged portion 44, if the target air-fuel ratio is changed (skipped) in correspondence to the inversion of the output of the oxygen sensor 57 during the execution of the active air-fuel ratio control routine mentioned above, the target injection amount is corrected so as to be increased and decreased in such a manner that the actual air-fuel ratio A/F agrees with the target air-fuel ratio. The rotation of the crankshaft 17 is accelerated or decelerated in accordance with this correction, and the torque of the crankshaft 17 is fluctuated. If the torque fluctuation amount at this time exceeds the maximum fluctuation amount which is allowable in the light of the drivability, the engaging portion 43 on the side of the internal combustion engine 11 is relatively rotated with respect to the engaged portion 44 on the side of the transmission 38, and the teeth 45 are disconnected form the teeth 46 as shown in FIG. 3A or brought into contact with the teeth 46 as shown in FIG. 3B so as to generate an abnormal noise and a vibration, so that there is a risk that the drivability of the vehicle 10 deteriorates.

Accordingly, in the present embodiment, the change of the target air-fuel ratio is limited by taking into consideration the fact that the allowable maximum fluctuation amount (the allowable maximum fluctuation amount) of the torque of the crankshaft 17 has the change amount (the allowable change amount A) of the corresponding air-fuel ratio A/F, and the allowable change amount A is different in correspondence to the intake air amount GA. Specifically, as shown in FIG. 5, there is a tendency that the allowable change amount A of the air-fuel ratio A/F becomes smaller in the case that the intake air amount GA is small, and becomes larger in accordance with the increase of the intake air amount GA.

This is because the torque of the crankshaft 17 is originally small at a time when the intake air amount GA is small, and the engaging portion 43 tends to be relatively rotated with respect to the engaged portion 44 even in the torque fluctuation at the smaller amount than that at a time when the intake air amount GA is large. In contrast, because the torque of the crankshaft 17 is originally large at a time when the intake air amount GA is large, and the engaging portion 43 is not relatively rotated with respect to the engaged portion 44 in the case that the torque fluctuation amount is not larger than that at a time when the intake air amount GA is small.

In the present embodiment, on the basis of the tendency mentioned above, in the case that the output of the oxygen sensor 57 is inverted, the allowable change amount A of the air-fuel ratio A/F corresponding to the intake air amount GA at the inverting time is employed. Further, the change (the skip) of the target air-fuel ratio is limited in such a manner as to prevent the change amount ΔA/F of the target air-fuel ratio in accordance with the inversion of the output of the oxygen sensor 57 from exceeding the allowable change amount A.

At a time of the limitation, the change amount of the target air-fuel ratio in the case that the target air-fuel ratio is changed to a rich air-fuel ratio from a lean air-fuel ratio or changed to a lean air-fuel ratio from a rich air-fuel ratio is set to a reference change amount ΔA/F (st) (refer to FIG. 6). The intake air amount GA corresponding to the same allowable change amount A(st) as the reference change amount ΔA/F(st) is used as a determination value β. Further, the case that the output of the oxygen sensor 57 is inverted under the state that the actual intake air amount GA is smaller than the determination value β is set to a condition for starting the limitation on the change of the target air-fuel ratio (a limit starting condition). Further, the target air-fuel ratio immediately before the inversion of the output of the oxygen sensor 57 is maintained after the limitation starting condition is established. If the intake air amount GA becomes equal to or more than the determination value β, the maintained target air-fuel ratio is changed at the reference change amount ΔA/F(st) amount. In other words, the case that the intake air amount GA becomes equal to or more than the determination value β is set to a condition for finishing the limitation on the change of the target air-fuel ratio (a limit finishing condition).

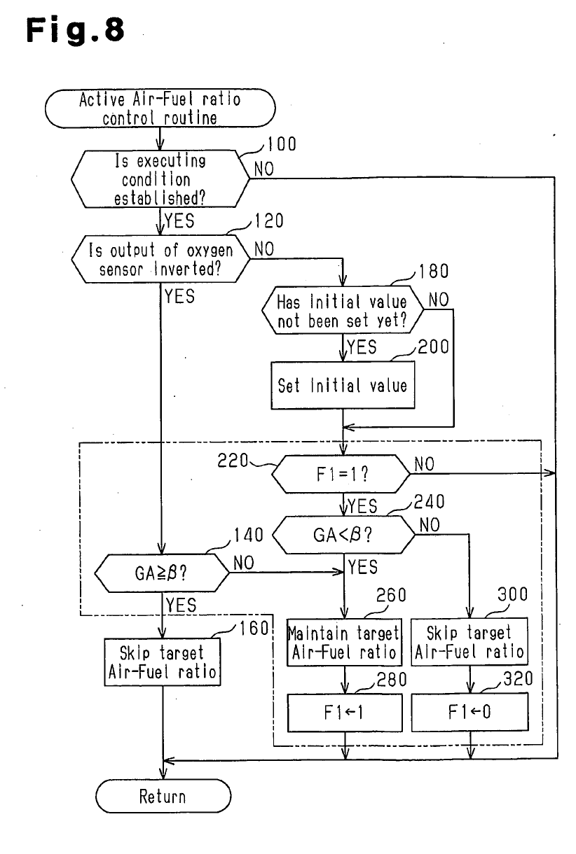

Specifically, each of the processes in the active air-fuel ratio control routine in FIG. 4 mentioned above is set to a base, and the process of limiting the change of the target air-fuel ratio is applied thereto. A flowchart in FIG. 8 shows an active air-fuel ratio control routine to which the limitation process is added, and is repeatedly executed every predetermined time by the electronic control apparatus 61. The added process corresponds to a process of steps 140 and 220 to 320 surrounded by a two-dot chain line in FIG. 8.

A flag F1 is used at a time of executing the active air-fuel ratio control routine. The flag F1 is provided for determining whether or not the condition for limiting the change of the target air-fuel ratio is established, specifically whether or not the time is in the period until the limitation finishing condition is established after the limitation starting condition is established. The initial value of the flag F1 is “0”, is switched to “1” in accordance with the establishment of the limitation starting condition, and is set back to “0” in accordance with the establishment of the limitation finishing condition mentioned above. In this case, in FIG. 8, the same step number is applied to the same process as that of FIG. 4, and a detailed description will be omitted.

The electronic control apparatus 61 determines in step 100 whether or not a condition for executing the active air-fuel ratio control (an execution condition) is established. If the determination condition is not satisfied (the execution condition is not established), the active air-fuel ratio control routine is temporarily finished.

In contrast, if the determination condition of step 100 is established (the execution condition is not established), in step 120, whether or not the output of the oxygen sensor 57 is inverted during the period from the previous control cycle to the present control cycle is determined. If the determination condition is satisfied, the process proceeds to step 140, and determines whether or not the intake air amount GA at that time point by the air flowmeter 53 is equal to or more than the determination value β.

The determination value β of the intake air amount GA corresponds to the same allowable change amount A(st) as the reference change amount ΔA/F(st) (refer to FIG. 5), as mentioned above. This means that if the intake air amount GA is equal to or more than the determination value β, the allowable change amount A of the air-fuel ratio A/F corresponding to the intake air amount GA is equal to or more than the same allowable change amount A(st) as the reference change amount ΔA/F(st). Accordingly, even if the target air-fuel ratio is changed to a rich air-fuel ratio from a lean air-fuel ratio, or vice versa at the reference change amount ΔA/F(st) under this condition, the change amount (the reference change amount ΔA/F(st)) does not exceed the allowable change amount A corresponding to the intake air amount GA at that time.

In contrast to the case mentioned above, if the intake air amount GA is smaller than the determination value β, that means that the allowable change amount A of the air-fuel ratio A/F corresponding to the intake air amount GA is smaller than the same allowable change amount A(st) as the reference change amount ΔA/F(st). Accordingly, if the target air-fuel ratio is changed at the reference change amount ΔA/F(st) under this condition, the change amount (the reference change amount ΔA/F(st)) exceeds the allowable change amount A corresponding to the intake air amount GA at that time.

From this point of view, if the determination condition of step 140 in FIG. 8 is satisfied (GA≧β), the process proceeds to step 160, and the target air-fuel ratio is changed to a rich air-fuel ratio from a lean air-fuel ratio or vise versa by changing the target air-fuel ratio at the reference change amount ΔA/F(st). Further, the active air-fuel ratio control routine is temporarily finished after the process of step 160. Accordingly, the target air-fuel ratio is largely changed every time when the output of the oxygen sensor 57 is inverted, on the condition that the intake air amount GA is equal to or more than the determination value β.

The change amount (the reference change amount ΔA/F(st)) of the target air-fuel ratio at this time does not exceed the allowable change amount A corresponding to the intake air amount GA at this time. Accordingly, the target injection amount is corrected so as to be increased and decreased in such a manner that the air-fuel ratio A/F agrees with the target air-fuel ratio, and the torque of the crankshaft 17 transmitted to the engaging portion 43 is fluctuated. However, the fluctuation amount does not exceed the allowable maximum fluctuation amount. The relative rotation of the engaging portion 43 with respect to the engaged portion 44 is suppressed, and the phenomenon that the abnormal noise and the vibration are generated due to separation and contact of the teeth 45 with the teeth 46 is hardly generated.

If the determination condition of step 140 is not satisfied (GA<β), it is determined that the limitation starting condition is established, and in step 260, the value immediately before the output of the oxygen sensor 57 is inverted, that is, a rich air-fuel ratio or a lean air-fuel ratio is maintained. Next, in step 280, the flag F1 is switched to “1” from “0”, and thereafter the active air-fuel ratio control routine is temporarily finished.

In this case, since the target air-fuel ratio is not changed, the torque fluctuation of the crankshaft 17 in accordance with the change of the target air-fuel ratio is not generated, or is small even if the torque fluctuation is generated. A change amount (≈0) of the target air-fuel ratio at this time is smaller than the allowable change amount A corresponding to the intake air amount GA, and the fluctuation amount of the torque of the crankshaft 17 does not exceed the allowable maximum change amount. Accordingly, although the intake air amount GA is smaller than the determination value β, the relative rotation of the engaging portion 43 with respect to the engaged portion 44 is suppressed in the same manner as the case of GA≧β, and the phenomenon that the abnormal noise and the vibration are generated is hardly generated.

On the other hand, if the determination condition of step 120 mentioned above is not satisfied (is not inverted), the process proceeds to step 220 after both of the processes of steps 180 and 200 mentioned above, or after only step 180. It is determined at step 220 whether or not the flag F1 is “1”. If the determination condition is not satisfied (F=0), the active air-fuel ratio control routine is temporarily finished. As a case in which the condition (F=0) mentioned above is generated, there can be listed up a case when the output of the oxygen sensor 57 has not been inverted yet immediately after the execution condition of the active air-fuel ratio control is established.

In contrast, if the determination condition of step 220 is satisfied (F=1), the target air-fuel ratio is maintained at least in the previous control cycle. In this case, in step 240, whether or not the intake air amount GA at that time point by the air flowmeter 53 is smaller than the determination value β, that is, the limitation finishing condition is satisfied is determined. If the determination condition is satisfied (GA<β), the process is executed in the order of step 260, step 280, and is then returned as mentioned above. Accordingly, the target air-fuel ratio is maintained at the value (a rich air-fuel ratio or a lean air-fuel ratio) immediately below the output of the oxygen sensor 57 is inverted, in the period (GA<β) that the determination condition of step 240 is satisfied.

Further, if the determination condition of step 240 mentioned above is not satisfied (GA≧β), it is determined that the limitation finishing condition is satisfied, and in step 300, by changing the target air-fuel ratio at the reference change amount ΔA/F(st), the process proceeds to a rich air-fuel ratio or a lean air-fuel ratio. Next, in step 320, the flag F1 is changed to “0” from “1”, and thereafter the active air-fuel ratio control routine is temporarily finished.

The change amount ΔA/F of the target air-fuel ratio in this case is the same as the reference change amount ΔA/F(st), and does not exceed the allowable change amount A corresponding to the intake air amount GA at that time, in the same manner as step 160 mentioned above. Accordingly, even if the rotation of the crankshaft 17 is accelerated or decelerated, and the torque of the crankshaft 17 transmitted to the engaging portion 43 is fluctuated, the fluctuation amount does not exceed the allowable maximum fluctuation amount. The relative rotation of the engaging portion 43 with respect to the engaged portion 44 is suppressed, and the phenomenon that the abnormal noise and the vibration are generated is hardly generated.

In the active air-fuel ratio control routine in FIG. 8 mentioned above, the process of steps 140 and 220 to 320 executed by the electronic control apparatus 61 (the process in the portion surrounded by a two-dot chain line) correspond to the processes executed by the limiting section.

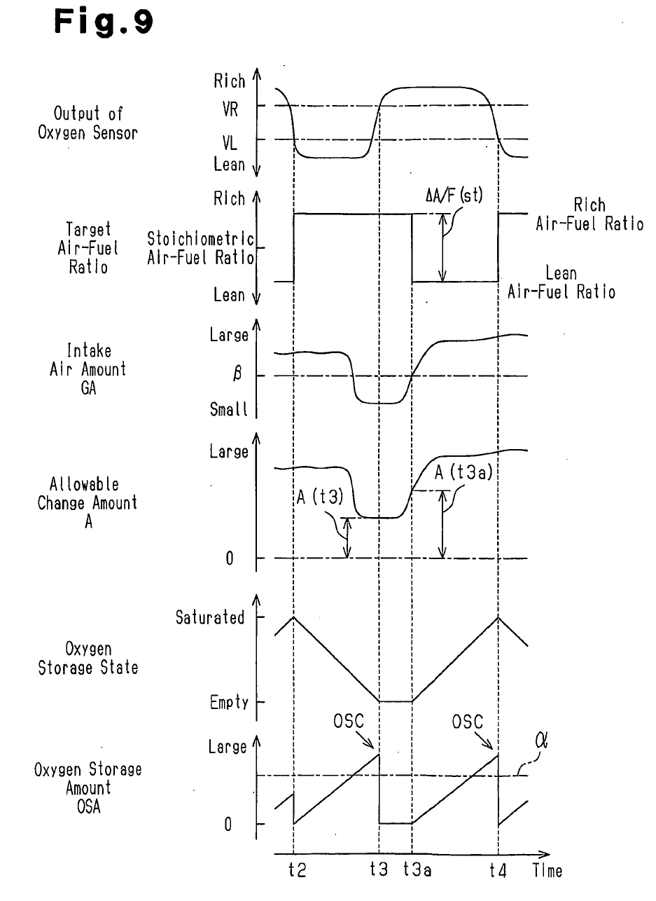

In accordance with the active air-fuel ratio control routine in FIG. 8 and the catalyst deterioration detecting routine in FIG. 7, the target air-fuel ratio, the allowable change amount A, the oxygen stored state and the oxygen storage amount OSA are changed in correspondence to the change of the output of the oxygen sensor 57, and the change of the intake air amount GA, for example, as shown in FIG. 9. This example is based on the timing chart in FIG. 6 mentioned above. FIG. 9 is different from FIG. 6 in the following two points. (i) The intake air amount GA is below the determination value β in the case that the output of the oxygen sensor 57 is inverted to a value corresponding to a rich air-fuel ratio from a value corresponding to a lean air-fuel ratio at the time t3, and (ii) the intake air amount GA becomes equal to or more than the determination value β at a time t3a.

Since the target air-fuel ratio is maintained at a rich air-fuel ratio in the period between the time t2 and time t3, the rich exhaust gas including the unburned combustible content starts flowing out to the downstream of the upstream catalyst 35 and the output of the oxygen sensor 57 is made richer, if the stored oxygen in the upstream catalyst 35 is all consumed so as to become in the empty state. The output of the oxygen sensor 57 exceeds the rich determination value VR at the time t3, and is changed (inverted) to a value corresponding to a rich air-fuel ratio from a value corresponding to a lean air-fuel ratio. The intake air amount GA at this time becomes smaller than the determination value β as mentioned above. Accordingly, in the active air-fuel ratio control routine in FIG. 8, the process is executed in the order of step 100, step 120, step 140, step 260, step 280, and is then returned, and the target air-fuel ratio is maintained at the value (the rich air-fuel ratio) immediately before the output of the oxygen sensor 57 is inverted. Further, the flag F1 is switched to “1” from “0”. On the other hand, in the catalyst deterioration detecting routine in FIG. 7, since the determination condition of step 540 is satisfied, the process of steps 560 and 580 is executed, and the oxygen storage amount OSA at that time point (the time t3) is set and stored as the oxygen storage capacity OSC, and the oxygen storage amount OSA is thereafter reset to “0”. A determination (steps 660 to 700) of the deterioration state of the upstream catalyst 35 is executed on the basis of the comparison between the oxygen storage capacity OSC and the determination value α. In this connection, in FIG. 9, since the oxygen storage capacity OSC is larger than the determination value α, a determination that the upstream catalyst 35 is normal (step 680) is executed.

In this case, since the target air-fuel ratio is not changed, the torque fluctuation of the crankshaft 17 in accordance with the change of the target air-fuel ratio is not generated, or is small even if it is generated. The change amount ΔA/F (≈0) of the target air-fuel ratio at this time is smaller than the allowable change amount A(t3) corresponding to the intake air amount GA, and the torque fluctuation amount in accordance therewith does not exceed the allowable maximum fluctuation amount of the torque of the crankshaft 17. Accordingly, although the intake air amount GA is smaller than the determination value β, the relative rotation of the engaging portion 43 with respect to the engaged portion 44 is suppressed, and the phenomenon that the abnormal noise and the vibration are generated due to separation and contact of the teeth 45 with the teeth 46 is hardly generated.

The intake air amount GA is smaller than the determination value β in the period between the time t3 and time t3a. Accordingly, in the active air-fuel ratio control routine in FIG. 8, the process is executed in the order of step 100, step 120, step 180, step 220, step 240, step 260, step 280, and is then returned. The target air-fuel ratio is maintained at the rich air-fuel ratio in accordance with these processes. An empty state in which the stored oxygen is all consumed continues in the upstream catalyst 35 in the period between the time t3 and time t3a.

If the intake air amount GA becomes equal to or more than the determination value β at the time t3a, the determination condition of step 240 is not satisfied in the active air-fuel ratio control routine. Accordingly, the process is executed in the order of step 100, step 120, step 180, step 220, step 240, step 300, step 320, and is then returned. The target air-fuel ratio is changed to a lean air-fuel ratio from a rich air-fuel ratio, and the flag F1 is switched to “0” from “1”.

As shown in FIG. 9, the change amount A/F of the target air-fuel ratio in this case is the same as the reference change amount ΔA/F(st), and is smaller than the allowable change amount A(t3a) corresponding to the intake air amount GA at that time point. Accordingly, even if the rotation of the crankshaft 17 is accelerated or decelerated and the torque of the crankshaft 17 transmitted to the engaging portion 43 is fluctuated, the fluctuation amount does not exceed the allowable maximum fluctuation amount. The relative rotation of the engaging portion 43 with respect to the engaged portion 44 is suppressed, and the phenomenon that the abnormal noise and the vibration are generated due to separation and contact of the teeth 45 with respect to the teeth 46 is hardly generated.

In accordance with the change of the target air-fuel ratio to a lean air-fuel ratio, the exhaust gas corresponding to the air-fuel mixture including oxygen and having a lean air-fuel ratio flows into the upstream catalyst 35. Since the upstream catalyst 35 stores the surplus oxygen in the exhaust gas, the oxygen storage amount OSA of the upstream catalyst 35 is increased after the time t3a.

In accordance with the first embodiment described above, the following advantages are obtained.

(1) In relation to the intake air amount GA, the change amount of the air-fuel ratio A/F corresponding to the allowable maximum fluctuation amount of the torque of the crankshaft 17 is employed as the allowable change amount A, and limit the change of the target air-fuel ratio in such a manner that the change amount of the target air-fuel ratio in accordance with the inversion of the output of the oxygen sensor 57 does not exceed the allowable change amount A. In accordance with this limit, the change amount of the torque of the crankshaft 17 does not exceed the allowable maximum fluctuation amount. As a result, the engaging portion 43 is relatively rotated with respect to the engaged portion 44 in the driven body (the transmission 38) side, and it is possible to suppress the matter that the abnormal noise and the vibration is generated due to separation and contact with respect to the engaged portion 44, and the drivability of the vehicle 10 is deteriorated.

Further, since the limitation mentioned above is executed during the active air-fuel ratio control, the opportunities of forcibly changing the target air-fuel ratio in correspondence to the inversion of the output of the oxygen sensor 57, calculating the oxygen storage capacity OSC in the period from the inversion to the next inversion, and detecting the deterioration of the upstream catalyst 35 on the basis of the oxygen storage capacity OSC are not reduced, unlike the case that the control is inhibited.

As mentioned above, in accordance with the first embodiment, it is possible to suppress the deterioration of the drivability of the vehicle 10 while ensuring the opportunities of detecting the deterioration of the upstream catalyst 35.

(2) The change amount ΔA/F of the target air-fuel ratio in the case that the target air-fuel ratio is changed to a rich air-fuel ratio from a lean air-fuel ratio or changed to a lean air-fuel ratio from a rich air-fuel ratio, is set to the reference change amount ΔA/F(st). The intake air amount GA corresponding to the same allowable change amount A(st) as the reference change amount ΔA/F(st) is used as the determination value β. The determination value β is compared with the actual intake air amount GA by the air flowmeter 53. Further, if the intake air amount GA is smaller than the determination value β, the limitation on the change of the target air-fuel ratio is started by assuming that the target air-fuel ratio exceeds the allowable change amount A(st) in the case that the target air-fuel ratio is changed at the reference change amount ΔA/F(st) under this condition. As mentioned above, it is possible to accurately determine the timing at which the limitation on the change of the target air-fuel ratio should be started, on the basis of the comparison between the intake air amount GA and the determination value β.

(3) If the limitation on the change of the target air-fuel ratio is started, the target air-fuel ratio (a rich air-fuel ratio or a lean air-fuel ratio) immediately below the inversion of the output of the oxygen sensor 57 is maintained. Accordingly, the torque fluctuation of the crankshaft 17 in accordance with the change of the target air-fuel ratio is not generated, or is small even if it is generated, and the fluctuation amount of the torque of the crankshaft 17 does not exceed the allowable maximum fluctuation amount.

Further, if the intake air amount GA becomes equal to or more than the determination value β, the target air-fuel ratio maintained as mentioned above is changed at the reference change amount ΔA/F(st), and the target air-fuel ratio is changed largely all at once from a lean air-fuel ratio to a rich air-fuel ratio or from a rich air-fuel ratio to a lean air-fuel ratio. The change amount of the target air-fuel ratio at this time is the reference change amount ΔA/F(st) and is large. However, the allowable change amount A of the air-fuel ratio A/F corresponding to the intake air amount GA becomes equal to or more than the same allowable change amount A(st) as the reference change amount ΔA/F(st). Under this condition, even if the target air-fuel ratio is largely changed, the change amount does not exceed the allowable change amount A corresponding to the intake air amount GA, and the fluctuation amount of the torque of the crankshaft 17 does not exceed the allowable maximum fluctuation amount.

As mentioned above, it is possible to limit the change of the target air-fuel ratio in such a manner that the change amount of the target air-fuel ratio in accordance with the inversion of the output of the oxygen sensor 57 does not exceed the allowable change amount A, and it is possible to ensure the advantage of the item (1) mentioned above.

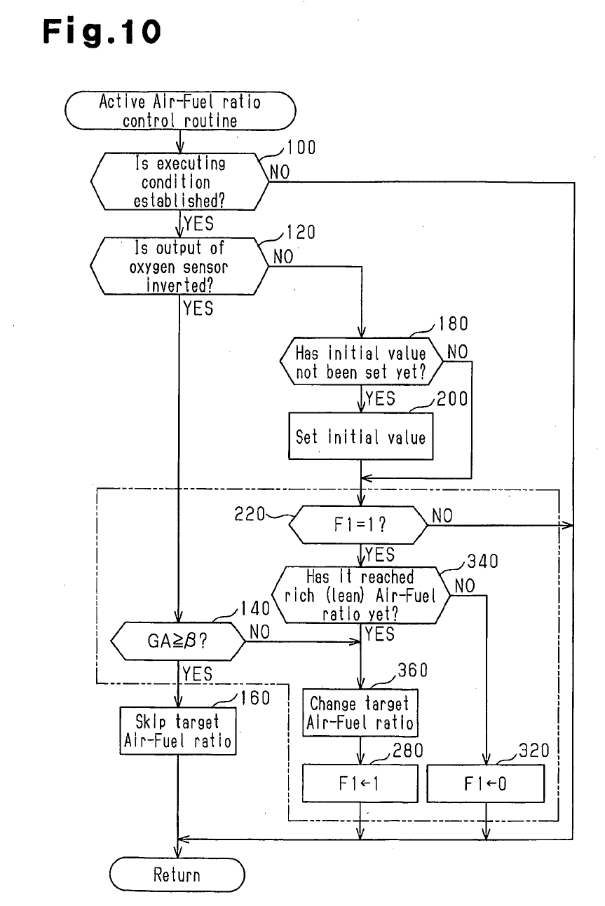

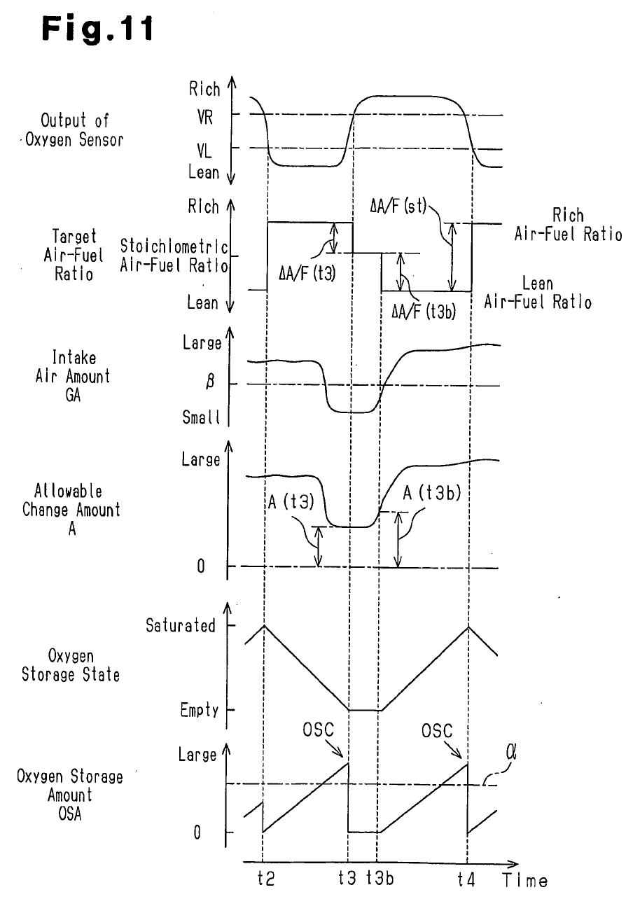

Next, a description will be given of a second embodiment according to the present invention with reference to FIGS. 10 and 11.

The second embodiment is different from the first embodiment in the limitation mode of the change of the target air-fuel ratio which is executed in the case that the output of the oxygen sensor 57 is inverted under the condition that the intake air amount GA is smaller than the determination value β, during the active air-fuel ratio control.

More specifically, in an active air-fuel ratio control routine shown in FIG. 10, the target air-fuel ratio is changed in stages at a smaller change amount than the allowable change amount A with respect to the intake air amount GA, at a time of the limitation on the change of the target air-fuel ratio, as shown by a portion surrounded by a two-dot chain line.

In this case, in FIG. 10, the same reference numerals are attached to the same processes as those in FIG. 8 mentioned above. FIG. 10 is different from FIG. 8 in the following three points: (a) a process of step 340 is executed in place of step 240; (b) a process of step 360 is executed in place of the process of step 260; and (c) the process of step 300 is omitted.

The electronic control apparatus 61 changes the target air-fuel ratio at the smaller change amount than the allowable change amount A with respect to the intake air amount GA as mentioned above, in step 360. The amount at this time may employ a previously set value, or may employ a value determined on the basis of the occasional allowable change amount A.

In step 340, whether or not the target air-fuel ratio does not reach the target value in a rich air-fuel ratio and a lean air-fuel ratio, that is, a different value from the value immediately before the output of the oxygen sensor 57 is inverted is determined. Accordingly, the process of step 360 is repeated until the determination condition of step 340 is not satisfied.

Further, if the target air-fuel ratio reaches a rich air-fuel ratio or a lean air-fuel ratio and the determination condition of step 340 is not satisfied, on the basis of the repeat of the process of step 360 mentioned above, the process proceeds to step 320. In step 320, the flag F1 is switched to “0” from “1”, and the active air-fuel ratio control routine is thereafter finished temporarily.

In the active air-fuel ratio control routine in FIG. 10 mentioned above, the processes of steps 140, 220, 340, 280 and 320 (the process of the portion surrounded by a two-dot chain line) executed by the electronic control apparatus 61 correspond to processes executed by the limiting section.

In accordance with the air-fuel ratio control routine in FIG. 10 and the catalyst deterioration detecting routine in FIG. 7, the target air-fuel ratio, the allowable change amount A, the oxygen storage state and the oxygen storage amount OSA are changed in correspondence to the change of the output of the oxygen sensor 57, and the change of the intake air amount GA, for example, as shown in FIG. 11. FIG. 11 corresponds to FIG. 9 mentioned above. In this embodiment, the intake air amount GA is below the determination value β in the case that the output of the oxygen sensor 57 is inverted to a value corresponding to a rich air-fuel ratio from a value corresponding to a lean air-fuel ratio at the time t3, in the same manner as FIG. 9.

If the target air-fuel ratio is maintained at a rich air-fuel ratio during the period between the time t2 and time t3, whereby the stored oxygen in the upstream catalyst 35 is all consumed, the rich exhaust gas including the unburned combustible content starts flowing out to the downstream side of the upstream catalyst 35, and the output of the oxygen sensor 57 is changed to a value corresponding to a rich air-fuel ratio. The output of the oxygen sensor 57 exceeds the rich determination value VR at the time t3, and is changed (inverted) to a value corresponding to a rich air-fuel ratio from a value corresponding to a lean air-fuel ratio. The intake air amount GA at this time becomes smaller than the determination value β as mentioned above, and the determination condition of step 140 is not satisfied. Accordingly, in the active air-fuel ratio control routine in FIG. 10, the process is executed in the order of step 100, step 120, step 140, step 360, step 280, and is then returned, and the target air-fuel ratio is changed at the smaller change amount ΔA/F(t3) than the allowable change amount A(t3) with respect to the intake air amount GA from the rich air-fuel ratio. Accordingly, even if the rotation of the crankshaft 17 is accelerated or decelerated and the torque of the crankshaft transmitted to the engaging portion 43 is fluctuated, the fluctuation amount does not exceed the allowable maximum fluctuation amount. The relative rotation of the engaging portion 43 with respect to the engaged portion 44 is suppressed, and the phenomenon that the abnormal noise and the vibration are generated due to separation and contact of the teeth 45 with respect to the teeth 46 is hardly generated. The teeth 45 keep being in contact with the teeth 46.

The change amount ΔA/F of the target air-fuel ratio at the time t3 is smaller than the reference change amount ΔA/F(st), and does not reach the target lean air-fuel ratio. Accordingly, in the next control cycle (the time t3b), the determination condition of step 340 is satisfied, the process is executed in the order of step 100, step 120, step 180, step 220, step 340, step 360, step 280, and is then returned, and the target air-fuel ratio is changed at the smaller change amount ΔA/F(t3b) than the allowable change amount A(t3b) with respect to the intake air amount GA. The target air-fuel ratio reaches the target lean air-fuel ratio in accordance with this change. Accordingly, even in this case, the fluctuation amount of the torque of the crankshaft 17 does not exceed the allowable maximum fluctuation amount. The relative rotation of the engaging portion 43 with respect to the engaged portion 44 is suppressed, and the phenomenon that the abnormal noise and the vibration are generated due to separation and contact of the teeth 45 with respect to the teeth 46 is hardly generated. In addition, in the case that the target air-fuel ratio exceeds a lean air-fuel ratio so as to become leaner than a lean air-fuel ratio in accordance with the change mentioned above, a lean air-fuel ratio may be set to the changed target air-fuel ratio.

Since the target air-fuel ratio reaches a lean air-fuel ratio and the determination condition is not satisfied, in the next control cycle at the time t3b, the process is executed in the order of step 100, step 120, step 180, step 220, step 340, step 320, and is then returned, and the change of the target air-fuel ratio is stopped.

In the control cycles after the next cycle, since the determination condition of step 220 is not satisfied, the process is executed in the order of step 100, step 120, step 180, step 220, and is then returned, and the target air-fuel ratio is maintained.

Accordingly, in accordance with the second embodiment, the following advantage is obtained in addition to the item (1) mentioned above.

(4) The target air-fuel ratio is changed in stages at the smaller change amount than the allowable change amount A with respect to the intake air amount GA, at a time of limiting the change of the target air-fuel ratio. Accordingly, the fluctuation amount of the torque fluctuating in accordance with the change of the target air-fuel ratio per one time does not exceed the allowable maximum fluctuation amount. Further, if the target air-fuel ratio is changed at the reference change amount AA/F(st) on the basis of the change in stages, the target air-fuel ratio comes to a lean air-fuel ratio or a rich air-fuel ratio.

As mentioned above, it is possible to limit the change of the target air-fuel ratio in such a manner that the change amount of the target air-fuel ratio in accordance with the inversion of the output of the oxygen sensor 57 does not exceed the allowable change amount A, and it is possible to ensure the advantage of the item (1) mentioned above.

The embodiment mentioned above may be modified as follows.

The present invention may be applied to the case that the output of the oxygen sensor 57 is inverted to a value corresponding to a lean air-fuel ratio from a value corresponding to a rich air-fuel ratio in an opposite manner, in addition to the case that the output is inverted to a value corresponding to a rich air-fuel ratio from a value corresponding to a lean air-fuel ratio. In other words, in the case that the output of the oxygen sensor 57 is inverted to a value corresponding to a lean air-fuel ratio from a value corresponding to a rich air-fuel ratio under the condition that the intake air amount GA is smaller than the determination value β, the change of the target air-fuel ratio may be limited. As a mode for limiting the target air-fuel ratio the limitation, the target air-fuel ratio may be maintained in the same manner as the first embodiment, or the target air-fuel ratio may be changed in stages in the same manner as the second embodiment.

The present invention may be widely applied to the vehicle provided with the engaging portion 43 rotating together with the crankshaft 17 and brought into contact with the engaged portion 44 in the driven body so as to transmit the torque between a driven body other than the transmission 38 and the internal combustion engine 11. Further, it is possible to employ any driven body as far as the driven body is driven by the transmission of the torque of the crankshaft 17. An auxiliary machine may be the driven body.

A correlation exists between the fuel injection amount and the torque of the crankshaft 17. Accordingly, in place of the target air-fuel ratio in each of the embodiments mentioned above, the change of the fuel injection amount may be limited. In other words, the change amount of the fuel injection amount corresponding to the maximum fluctuation amount allowable in the torque of the crankshaft 17 is determined as the allowable change amount A, with respect to the intake air amount GA, and the change of the fuel injection amount is limited in such a manner as to prevent the change amount of the fuel injection amount from exceeding the allowable change amount A at a time when the output of the oxygen sensor 57 is inverted.

In this case, at a time of limiting the change of the fuel injection amount, the change amount (the allowable change amount) of the fuel injection amount corresponding to the allowable maximum fluctuation amount of the torque of the crankshaft 17 with respect to the intake air amount GA is employed. Further, the change of the fuel injection amount is limited in such a manner as to prevent the change amount of the fuel injection amount in accordance with the inversion of the output of the oxygen sensor from exceeding the allowable change amount. In accordance with this limit, the fuel injection amount does not exceed the allowable change amount A, and the torque of the crankshaft 17 does not exceed the allowable maximum fluctuation amount. As a result, the engaging portion 43 is relatively rotated with respect to the engaged portion 44, and it is possible to suppress the generation of the abnormal noise and the vibration due to separation and contact of the engaging portion 43 with respect to the engaged portion 44, and the deterioration of the drivability of the vehicle 10.

Further, since the limitation is executed during the active air-fuel ratio control, it is possible to suppress the reduction of each of the opportunities of forcibly changing the target air-fuel ratio in accordance with the inversion of the output of the oxygen sensor 57, calculating the oxygen storage capacity OSC during the period from the inversion to the next inversion, and detecting the deterioration of the catalyst 35 on the basis of the oxygen storage capacity OSC, unlike the case of inhibiting the control.

As mentioned above, it is possible to suppress the deterioration of the drivability of the vehicle 10 while ensuring the opportunities of detecting the deterioration of the upstream catalyst 35.

In the catalyst deterioration detecting routine in FIG. 7, an average value of the oxygen storage capacities OSC set and stored in step 560 may be employed as the oxygen storage capacity OSC used for determining the deterioration of the upstream catalyst 35 (steps 660 to 700).

As the condition for starting the limitation on the change of the target air-fuel ratio (the limitation starting condition), it is possible to employ, in place of the condition described in each of the embodiments, a condition that “the change amount A/F of the target air-fuel ratio in accordance with the inversion of the output of the oxygen sensor 57 is larger than the allowable change amount A with respect to the intake air amount GA at this time.”.

In the second embodiment, the condition for finishing the limitation on the change of the target air-fuel ratio (the limitation finishing condition) may be set to a condition that one of the following two conditions I and II is established earlier than the other.

Condition I: the intake air amount GA becomes equal to or more than the determination value β.

Condition II: a changed target air-fuel ratio reaches a rich air-fuel ratio or a lean air-fuel ratio.

In the second embodiment, the target air-fuel ratio may be changed in stages at three times or more at a time of limiting the target air-fuel ratio. In this case, the change amount of the target air-fuel ratio in each of the times is set to be smaller than the allowable change amount A with respect to the intake air amount GA.

1. A catalyst deterioration detecting apparatus of a vehicle internal combustion engine, wherein the engine executes fuel injection in such manner that an air-fuel ratio of mixture of intake air and fuel agrees with a target air-fuel ratio, and purifies exhaust gas generated in combustion of the air-fuel mixture, using an exhaust gas purifying catalyst that stores or releases oxygen, wherein the vehicle includes a driven body that is driven by torque of an output shaft of the engine, and an engaging portion provided between the engine and the driven body, the engaging portion being contactable with the driven body to transmit the torque of the output shaft to the driven body, the apparatus comprising:
an oxygen sensor detecting a concentration of oxygen of the exhaust gas at the downstream side of the exhaust gas purifying catalyst, wherein the concentration of oxygen in the exhaust gas correlates to the air-fuel ratio of the air-fuel mixture, and wherein the oxygen sensor outputs a first signal indicating that the air-fuel ratio of the air-fuel mixture is leaner than a stoichiometric air-fuel ratio, and a second signal indicating that the air-fuel ratio of the air-fuel mixture is richer than the stoichiometric air-fuel ratio;
a control section executing active air-fuel ratio control, wherein, in the active air-fuel ratio control, the control section changes the target air-fuel ratio from a lean air-fuel ratio, which is leaner than the stoichiometric air-fuel ratio, to a rich air-fuel ratio, which is richer than the stoichiometric air-fuel ratio, on the condition that the signal output from the oxygen sensor is changed from the second signal to the first signal, and the control section changes the target air-fuel ratio from the rich air-fuel ratio to the lean air-fuel ratio on the condition that the signal output from the oxygen sensor is changed from the first signal to the second signal; a determining section, wherein, during the execution of the active air-fuel ratio control, the determining section integrates the amount of oxygen that is stored in or released from the exhaust gas purifying catalyst from when the signal output from the oxygen sensor is changed until when the signal is changed subsequently, thereby calculating an oxygen storage capacity, and wherein the determining section uses the calculated oxygen storage capacity to determine a deterioration state of the exhaust gas purifying catalyst; and
a limiting section, wherein the limiting section sets, as an allowable change amount, a change amount of the air-fuel ratio that corresponds to an allowable maximum fluctuation amount of the torque of the output shaft, the allowable change amount is varied according to the amount of the intake air, and wherein the limiting section limits a change of the target-air fuel ratio such that a change amount of the target air-fuel ratio due to a change of the signal output from the oxygen sensor does not exceed the allowable change amount.

2. The apparatus according to claim 1, wherein the limiting section uses a smaller allowable change amount when the intake air amount is small than when the intake air amount is large.

3. The apparatus according to claim 2, wherein the limiting section sets, as a reference change amount, the change amount of the target air-fuel ratio when the target air-fuel ratio is changed between a lean air-fuel ratio and a rich air-fuel ratio, and sets, as a determination value, the amount of intake air that corresponds to an allowable change amount that is equal to the reference change amount, and wherein, when the actual intake air amount is less than the determination value, the limiting section starts limitation on a change of the target air-fuel ratio if the signal output from the oxygen sensor is changed.

4. The apparatus according to claim 3, wherein, after starting the limitation, the limiting section maintains the target air-fuel ratio immediately before a change of the signal output from the oxygen sensor, and wherein, when the intake air amount is equal to or more than the determination value, the limiting section changes the target air-fuel ratio from the maintained value by the amount corresponding to the reference change amount.

5. The apparatus according to claim 2, wherein, when limiting the target air-fuel ratio, the limiting section changes in stages the target-air fuel ratio by a change amount that is less than the allowable change amount of the intake air amount at a time.

6. A catalyst deterioration detecting apparatus of a vehicle internal combustion engine, wherein the engine executes fuel injection in such manner that an air-fuel ratio of mixture of intake air and fuel agrees with a target air-fuel ratio, and purifies exhaust gas generated in combustion of the air-fuel mixture, using an exhaust gas purifying catalyst that stores or releases oxygen, wherein the vehicle includes a driven body that is driven by torque of an output shaft of the engine, and an engaging portion provided between the engine and the driven body, the engaging portion being contactable with the driven body to transmit the torque of the output shaft to the driven body, the apparatus comprising:
an oxygen sensor detecting a concentration of oxygen of the exhaust gas at the downstream side of the exhaust gas purifying catalyst, wherein the concentration of oxygen in the exhaust gas correlates to the air-fuel ratio of the air-fuel mixture, and wherein the oxygen sensor outputs a first signal indicating that the air-fuel ratio of the air-fuel mixture is leaner than a stoichiometric air-fuel ratio, and a second signal indicating that the air-fuel ratio of the air-fuel mixture is richer than the stoichiometric air-fuel ratio;
a control section executing active air-fuel ratio control, wherein, in the active air-fuel ratio control, the control section changes the target air-fuel ratio from a lean air-fuel ratio, which is leaner than the stoichiometric air-fuel ratio, to a rich air-fuel ratio, which is richer than the stoichiometric air-fuel ratio, on the condition that the signal output from the oxygen sensor is changed from the second signal to the first signal, and the control section changes the target air-fuel ratio from the rich air-fuel ratio to the lean air-fuel ratio on the condition that the signal output from the oxygen sensor is changed from the first signal to the second signal;
a determining section, wherein, during the execution of the active air-fuel ratio control, the determining section integrates the amount of oxygen that is stored in or released from the exhaust gas purifying catalyst from when the signal output from the oxygen sensor is changed until when the signal is changed subsequently, thereby calculating an oxygen storage capacity, and wherein the determining section uses the calculated oxygen storage capacity to determine a deterioration state of the exhaust gas purifying catalyst; and
a limiting section, wherein the limiting section sets, as an allowable change amount, a change amount of fuel injection that corresponds to an allowable maximum fluctuation amount of the torque of the output shaft, the allowable change amount is varied according to the amount of the intake air, and wherein the limiting section limits a change of the fuel injection amount such that a change amount of the target air-fuel ratio due to a change of the signal output from the oxygen sensor does not exceed the allowable change amount.

7. The apparatus according to claim 3, wherein, when limiting the target air-fuel ratio, the limiting section changes in stages the target-air fuel ratio by a change amount that is less than the allowable change amount of the intake air amount at a time.
